(19) United States
(12) Patent Application Publication
(10) Pub. No.: US 2018/0329483 A1
(43) Pub. Date: Nov. 15, 2018

(54) THREE-DIMENSIONAL POSITIONING SYSTEM AND METHOD THEREOF

(71) Applicant: ASUSTeK COMPUTER INC., TAIPEI (TW)

(72) Inventors: Ping-Fu HSIEH, TAIPEI (TW); Chih-Lung LIN, TAIPEI (TW); Chun-Chieh CHUANG, TAIPEI (TW); Hui-Chun CHUNG, TAIPEI (TW); Wei-Chung HUNG, TAIPEI (TW); Pei-Lun HAN, TAIPEI (TW); Tse-Wei LIN, TAIPEI (TW)

(21) Appl. No.: 15/968,822

(22) Filed: May 2, 2018

(30) Foreign Application Priority Data
May 12, 2017 (TW) 106115828

(51) Int. Cl. G06F 3/01; G06T 11/00

(52) U.S. Cl. CPC G06F 3/011; G06T 11/00

(57) ABSTRACT

A 3D positioning system and method, adapted for object tracking and positioning of virtual reality is provided. The method comprises: tracking a characteristic of at least a light-emitting component at a controller; calculating relative displacement information between each of the controller and a headset display device according to the characteristic; detecting first displacement information of the headset display device and second displacement information of each of the controller; transmitting the relative displacement information, the first displacement information, and the second displacement information to the host; and adjusting a corresponding virtual image of the virtual reality according to the relative displacement information, the first displacement information, and the second displacement information and transmitting the adjusted virtual image to the headset display device to display via the host.

### CROSS-REFERENCE TO RELATED APPLICATION

This application claims the priority benefit of TW application serial No. 106115828, filed on May 12, 2017. The entirety of the above-mentioned patent application is hereby incorporated by references herein and made a part of specification.

### BACKGROUND OF THE INVENTION

### Field of the Invention

The disclosure relates to a three-dimensional (3D) positioning system and a 3D positioning method.

### Description of the Related Art

Conventionally, an external device in the service environment is necessary for a virtual reality technology. The external device is configured for positioning a head-mounted display, a controller, and a user. For example, the external device is a laser scanning positioning device or an infrared camera.

### BRIEF SUMMARY OF THE INVENTION

According to an aspect of the disclosure, a 3D positioning system is provided. The3D positioning system, adapted for object tracking and positioning of virtual reality, the 3D positioning system comprises: at least a controller, wherein each of the controller includes at least a light-emitting component; a headset display device coupled with the controller, the headset display device including: an object tracking module including a first inertial measurement unit configured to detect first displacement information of the headset display device, and at least a digital camera configured to track a characteristic of the light-emitting component at the controller; and a host configured to adjust a virtual image corresponding to the virtual reality and transmit the adjusted virtual image to the headset display device to display.

According to an aspect of the disclosure, a 3D positioning method is provided. The 3D positioning method is adapted for object tracking and positioning of virtual reality. The 3D positioning method comprises: Tracking a characteristic of at least a light-emitting component at a controller; calculating relative displacement information between each of the controller and a headset display device according to the characteristic; detecting first displacement information of the headset display device and second displacement information of each of the controller; transmitting the relative displacement information, the first displacement information, and the second displacement information to the host; and adjusting a corresponding virtual image of the virtual reality according to the relative displacement information, the first displacement information, and the second displacement information and transmitting the adjusted virtual image to the headset display device to display via the host.

### BRIEF DESCRIPTION OF THE DRAWINGS

FIG. 1 is a block diagram showing a 3D positioning system in an embodiment.

FIG. 2 is a flow diagram showing a 3D positioning system in an embodiment.

FIG. 3 is a block diagram showing a 3D positioning system in an embodiment.

FIG. 4 is a block diagram showing an object tracking module of a 3D positioning system in an embodiment.

FIG. 5 is a block diagram showing a controller tracking module of a 3D positioning system in an embodiment.

### DETAILED DESCRIPTION OF THE EMBODIMENTS

These and other features, aspects, and advantages of the present invention will become better understood with regard to the following description, appended claims, and accompanying drawings. However, the invention is not limited to the embodiments.

The term “coupled” means that wireless or wired connection. In addition, the transmission interface includes a wired or wireless transmission interface.

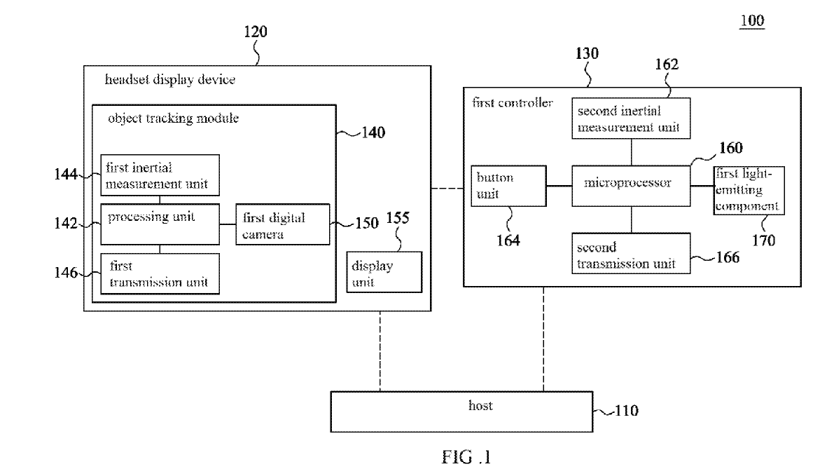

A 3D positioning system 100 adapted for object tracking and positioning of virtual reality is provided. FIG. 1 is a block diagram showing a 3D positioning system in an embodiment. The 3D positioning system 100 includes a host 110, a headset display device 120, and a first controller 130. The headset display device 120 is coupled with the first controller 130. The headset display device 120 includes an object tracking module 140 and a display unit 155. The object tracking module 140 includes a processing unit 142, a first inertial measurement unit (IMU) 144, a first transmission unit 146, and a first digital camera 150. The processing unit 142 is coupled with the first inertial measurement unit 144, the first transmission unit 146 and the first digital camera 150. The first controller 130 includes a microprocessor 16, a second inertial measurement unit 162, a button unit 164, a second transmission unit 166, and a first light-emitting component 170. The microprocessor 160 is coupled with the second inertial measurement unit 162, the button unit 164, the second transmission unit 166, and the first light-emitting component 170.

The host 110 is connected with the headset display device 120 via a transmission interface. The host 110 is connected with the first controller 130 via a transmission interface. In an embodiment, the transmission interface is a cable, Bluetooth, wireless LAN, Worldwide Interoperability for Microwave Access (WiMAX) or Long Term Evaluation (LTE). The host 110 is hardware, such as a computer, a mobile device, or a computing device, which is not limited herein.

In an embodiment, the first light-emitting component 170 is a Light-emitting diode (LED), such as a far infrared LED, which is not limited herein.

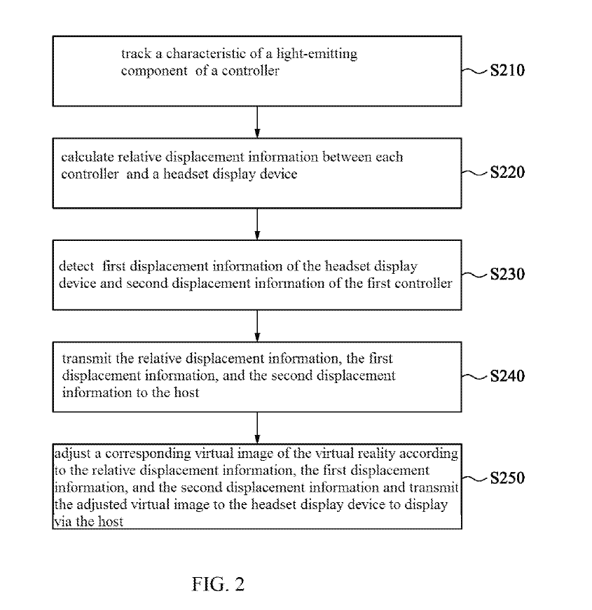

FIG. 2 is a flow diagram showing a 3D positioning system in an embodiment. Please refer to FIG. 1 and FIG. 2. First, the first digital camera 150 of the object tracking module 140 tracks a characteristic of the first light-emitting component 170 of the first controller 130 (step S210). Then, the processing unit 142 of the object tracking module 140 calculates the relative displacement information between the first controller 130 and the headset display device 120 (step S220). In an embodiment, the characteristic is a shape or an arrangement of the light-emitting components. Then, the first inertial measurement unit 144 detects the first displacement information of the headset display device 120, and the second inertial measurement unit 162 detects the second displacement information of the first controller 130 (step S230). Next, the relative displacement information, the first displacement information, and the second displacement information are transmitted to the host 110 (step S240). The host 110 adjusts the virtual image corresponding to the virtual reality according to the relative displacement information, the first displacement information, and the second displacement information. The adjusted virtual image is transmitted to the display unit 155 of the headset display device 120 to display (step S250).

In an embodiment, the first displacement information and the second displacement information at least include a rotation angle and a displacement direction. The relative displacement information at least includes a relative distance and a displacement direction.

The first inertial measurement unit 144 of the headset display device 120 detects the relative displacement information calculated by the processing unit 142 and the first displacement information of the headset display device 120. The first transmission unit 146 transmits the relative displacement information and the first displacement information to the host 110. The second inertial measurement unit 162 of the first controller 130 detects the second displacement information of the first controller 130. The microprocessor 160 of the first controller 130 transmits the second displacement information to the host 110 via the second transmission unit 166.

In the embodiment, the first controller 130 further includes at least a button unit 164. When the microprocessor 160 detects the button unit 164 is pressed, an enable signal is transmitted to make the first light-emitting component 170 light.

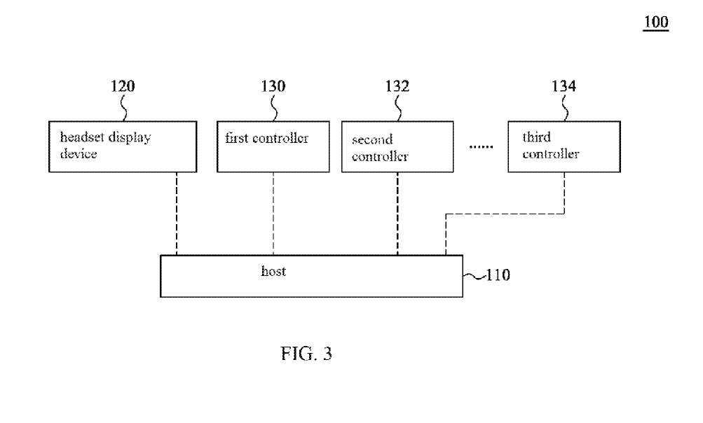

In an embodiment, the number of the controllers is more than one. FIG. 3 is a block diagram showing a 3D positioning system in an embodiment. In comparison with that in FIG. 1, a 3D positioning system 100 in FIG. 3 further includes other controllers, the first controller 130, the second controller 132 and the third controller 134 in FIG. 3. In the embodiment, the second controller 132, the third controller 134 and the first controller 130 have same components. In an embodiment, the light-emitting components at the first controller 130, the second controller 132 and the third controller 134 have different types, such as shapes of triangle, quadrangle, and circle.

In an embodiment, the light-emitting components at the first controller 130, the second controller 132 and the third controller 134 have different brightness. Then, the object tracking module 140 identifies different controllers of the headset display device 120 according to the brightness.

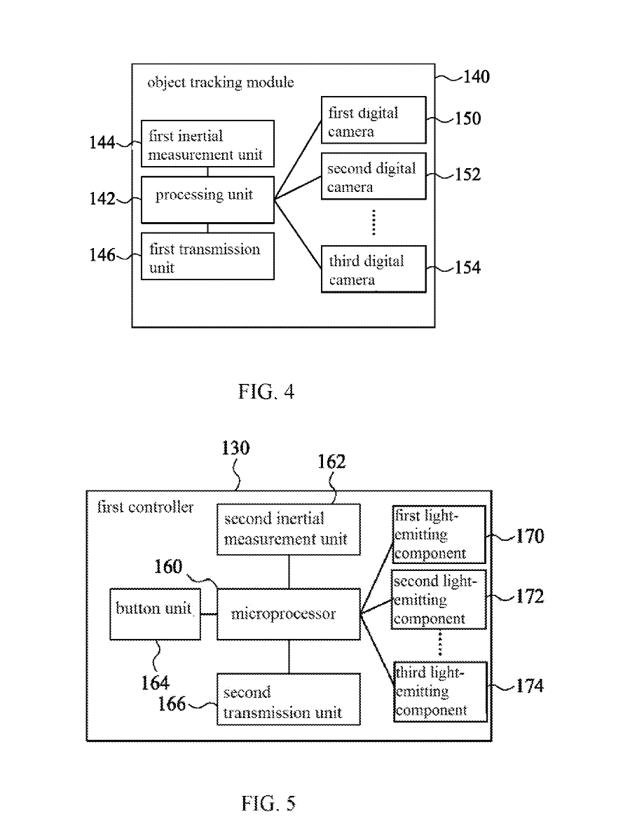

In an embodiment, the object tracking module 140 includes a plurality of digital cameras. FIG. 4 is a block diagram showing an object tracking module of a 3D positioning system in an embodiment. The object tracking module includes a plurality of digital cameras, a first digital camera 150, a second digital camera 152, and a third digital camera 154 as shown in FIG. 4. Different digital cameras track the controllers 130 from different angles. In an embodiment, the digital cameras include detecting components which detect the brightness of the LEDs, which is not limited herein.

In an embodiment, one controller includes a plurality of light-emitting components. FIG. 5 is a block diagram showing a controller tracking module of a 3D positioning system in an embodiment. The first controller 130 includes the first light-emitting component 170, the second light-emitting component 172, and the third light-emitting component 174. In an embodiment, the light-emitting components have different shapes, such as triangle, quadrangle, and circle. Then, the object tracking module 140 of the headset display device 120 easily identifies the light-emitting components.

According to a 3D positioning system in embodiments, an object tracking module is configured at a headset display device worn on users. Then, a controller hold by users is tracked and positioned. Therefore, an external device for positioning a controller, a head-mounted display, and users in the environment does not need to be set up in advance. In addition, according to the 3D positioning system in embodiments, the object tracking module tracks a characteristic of the light-emitting component of the controller, and the relative displacement information between the headset display device and the controller. Then, the calculated result is transmitted to the host via a transmission interface. Since part of data calculating is finished in the headset display device, the data size transmitted to the host is reduced. As a result, the burden on the host is reduced.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A 3D positioning system, adapted for object tracking and positioning of virtual reality, the 3D positioning system comprising:
at least a controller, wherein each of the controller includes at least a light-emitting component;
a headset display device coupled with the controller, the headset display device including:
an object tracking module including a first inertial measurement unit configured to detect first displacement information of the headset display device, and
at least a digital camera configured to track a characteristic of the light-emitting component at the controller; and
a host configured to adjust a virtual image corresponding to the virtual reality and transmit the adjusted virtual image to the headset display device to display.

2. The 3D positioning system according to claim 1, wherein the controller includes:
a second transmission unit;
a second inertial measurement unit configured to detect second displacement information of the corresponding controller; and
a microprocessor connected with the second inertial measurement unit and the second transmission unit, the microprocessor transmits the second displacement information to the host via the second transmission unit.

3. The 3D positioning system according to claim 2, wherein the object tracking module further includes:
a processing unit coupled with the first inertial measurement unit and the digital camera, the processing unit calculates relative displacement information between the controller and the headset display device according to the characteristic tracked by the digital camera.

4. The 3D positioning system according to claim 3, wherein the object tracking module further includes:
a first transmission unit coupled with the processing unit, the first transmission unit is configured to transmit a distance and a direction of the relative displacement information and the first displacement information to the host.

5. The 3D positioning system according to claim 2, wherein the host adjusts the virtual image of the virtual reality according to the relative displacement information, the first displacement information, and the second displacement information and transmits the adjusted virtual image to the headset display device to display.

6. The 3D positioning system according to claim 1, wherein the characteristic is a shape or an arrangement of the light-emitting component.

7. The 3D positioning system according to claim 1, wherein the headset display device further includes:
a display unit configured to display the virtual image.

8. The 3D positioning system according to claim 1, wherein the light-emitting component includes at least one LED.

9. A 3D positioning method, adapted for object tracking and positioning of virtual reality, the 3D positioning method comprising:
tracking a characteristic of at least a light-emitting component at a controller;
calculating relative displacement information between each of the controller and a headset display device according to the characteristic;
detecting first displacement information of the headset display device and second displacement information of each of the controller;
transmitting the relative displacement information, the first displacement information, and the second displacement information to the host; and
adjusting a corresponding virtual image of the virtual reality according to the relative displacement information, the first displacement information, and the second displacement information and transmitting the adjusted virtual image to the headset display device to display via the host.

10. The 3D positioning method according to claim 9, wherein the characteristic is a shape or an arrangement of the light-emitting component.
